(19) United States
(12) Patent Application Publication
(10) Pub. No.: US 2002/0090973 A1
(43) Pub. Date: Jul. 11, 2002

(54) Method and apparatus for the control of a wireless phone

(75) Inventor: Robert K. Tendler, Chestnut Hill, MA (US)

Correspondence Address: Robert K. Tendler, 65 Atlantic Avenue, Boston, MA, 02110, US

(73) Assignee: TENDLER CELLULAR, INC.

(21) Appl. No.: 09/756,839

(22) Filed: Jan. 9, 2001

(51) Int. Cl. H04Q 7/20

(52) U.S. Cl. 455/552; 455/404; 455/456; 455/564; 455/426; 455/553

(57) ABSTRACT

The control of a wireless phone from a universal module having a predetermined serial output stream is provided to a minicompiler or microprocessor which compiles the output from the module into a form compatible with an existing wireless phone, either by converting the predetermined format into one acceptable to the phone or by providing that the serial data be transformed into switch closure signals which are directly coupled to the keypad of the phone. In this manner a module such as a GPS-based locator system may be utilized to control the phone to dial a particular phone number and to provide the GPS data either by directly controlling the data transfer mechanism within the wireless phone or by actuating the key switches to dial the particular phone number and to then provide the location information via switch activations.

### FIELD OF INVENTION

This invention relates to wireless phone and more particularly to a system for automatically adapting the output of a module to control an existing wireless phone regardless of its internal bus structure or operation.

### BACKGROUND OF THE INVENTION

As will be appreciated, wireless phones are manufactured with a predetermined bus structure which controls the operation of the wireless phone. While in the past there have been attempts to make the bus structure identical for all models of wireless phones, the functions of these phones require the bus structures of the different models to be different.

This presents the problem of one seeking to control an already existing phone with an already existing bus structure. While it is indeed possible to obtain the bus structure of the phone and to be able to drive the bus structure so as to dial the phone and to provide various functions, it is a virtual impossibility to do so with a module which is intended to be universal and to be connected to all types of phones.

One typical situation is that in which a wireless phone is to be dialed with a predetermined number, which in one case is an emergency number generated by emergency locator system in which the number to be dialed would, for instance, be 911. As illustrated in U.S. Pat. No. 6,014,555, issued to Robert K. Tendler on Jan. 11, 2000, an emergency locator system is provided in which a module including a GPS receiver is utilized to have a wireless phone dial a particular number and to report latitude and longitude.

While this patent teaches that the latitude and longitude is to be provided through a verbal rendition from a speech chip on the module, it is possible to be able to signal position through the utilization of DTMF or TouchTones over the voice channel or signal channel of the wireless phone.

While in the past it has been possible with certain phones to be able to couple to the internal bus structure of the phone and be able to perform dialing and DTMF tone generating functions, oftentimes it is the case that the bus structure either does not exist in the phone or it is of a nature which is not available from the handset manufacturer.

This puts the manufacturer of a universal module in a quandary as to how to be able to control the wireless phone absent knowledge or permission to use the particular bus structure, if it exists.

### SUMMARY OF THE INVENTION

In the subject invention, a universal module having a specified output is connected to a microprocessor or compiler, the purpose of which is to change the predetermined format of the code on the output bus to that which is compatitable with either the bus structure of a particular wireless phone or to activate the individual switches of the keypad of the particular phone so that at the very least a particular phone number can be dialed. Further the subject system controls the function of the phone such as, for instance, to change the operation of the phone from one air interface to another air interface or in general to control various modes of the phone.

In the case where GPS derived location information is to be sent in alpha-numeric characters, in one embodiment, if the microcompiler is utilized to drive the switch closures for the various switches on the keypad then the location can be transmitted by virtue of actuating the various switches of the keypad from the universal module.

Thus, not only can location be transmitted, for instance, in DTMF tones, other information generated at the universal module can be transmitted by virtue of the activation of the various keys on the keypad.

What is therefore accomplished is the ability to fabricate a universal module which controls an existing phone so that the universal module need not be reprogrammed for the particular bus structure of the particular phone. Nor need the module be reconfigured with an array of switch closing transistors to control corresponding keys on the keypad of the particular phone.

In one embodiment, the microcompiler is connected to the serial data port for the module which produces a coded bit stream in a particular format to provide a particular function. The microcompiler, changes the format to signals which are compatitable with the bus structure of the phone, if the phone has such a bus structure so as to be able, for instance, to turn on the phone, have it dial a particular number, and provide information through whatever modulation means the phone has, be it DTMF, short message units, modem transmission, or packet data transmission.

Alternatively, if no such bus structure is available at the phone, the microcompiler, can be utilized to generate switch closing signals which are provided on a flexible printed circuit to bridge the individual switches of the keypad of the wireless phone.

In this manner, control over the wireless phone is accomplished without having to modify either the universal module or the phone in order to provide for the control necessary for the transmission of the information developed by the universal module.

In summary, the control of a wireless phone from a universal module having a predetermined serial output stream is provided to a minicompiler or microprocessor which compiles the output from the module into a form compatible with an existing wireless phone, either by converting the predetermined format into one acceptable to the phone or by providing that the serial data be transformed into switch closure signals which are directly coupled to the keypad of the phone. In this manner a module such as a GPS-based locator system may be utilized to control the phone to dial a particular phone number and to provide the GPS data either by directly controlling the data transfer mechanism within the wireless phone or by actuating the key switches to dial the particular phone number and to then provide the location information via switch activations.

### BRIEF DESCRIPTION OF THE DRAWINGS

These and other features of the subject invention will be better understood in connection with the Detailed Description in conjunction with the Drawings, of which:

FIG. 1 is a diagrammatic illustration of the control of the wireless phone from a universal module, in which the wireless phone is provided with an emergency location system embodied in the module, in which a GPS receiver and the remainder of the system is implemented via a system-on-a-chip module and is connected to the wireless phone through the subject system to be able to control its functions;

FIG. 2 is a diagrammatic illustration of one embodiment of the subject invention in which a minicompiler is interposed between the universal module and the keypads of a wireless phone in which the minicompiler receives serial data in a particular format from a microprocessor on the module, with the output of the minicompiler controlling the individual switch closures of the keypad of the wireless phone; and,

FIG. 3 is a diagrammatic illustration of another embodiment of the subject invention in which a minicompiler is interposed between the universal module and the wireless phone in which the output of the minicompiler is coupled to a serial port of the wireless phone to transform the format of the serial data stream from the universal module into that compatible with the format of the serial data input for the wireless phone.

### DETAILED DESCRIPTION

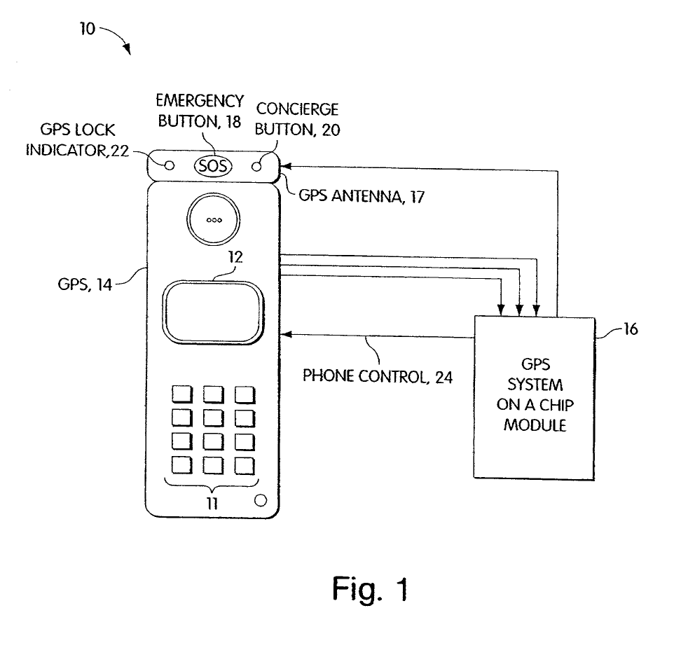

Referring now to FIG. 1, a wireless phone 10 having a display 12 and a keypad 14 is provided in one embodiment with a GPS receiver 14, which is coupled to a universal module 16 that, in one embodiment, can include the GPS receiver. A GPS antenna 17 may be included in phone 10 within a pod at the top of the phone as illustrated. The phone may be supplied with an emergency button 18 and a concierge/roadside assistance button 20 on the face of the pod, both of which are coupled to universal module 16 for the activation thereof. Additionally, a GPS lock indication 22 is provided and is driven by module 16.

In operation, when the universal module functions as a GPS locator module, activation thereof causes the module to output signals to provide for the control of the wireless phone 10 over line 24 so that, in one embodiment, the phone is turned on, a particular phone number is dialed, and GPS-driven location is transmitted via the wireless phone to a remote location.

As mentioned hereinbefore, with an existing wireless phone, the wireless phone may or may not have a bus structure for the control thereof.

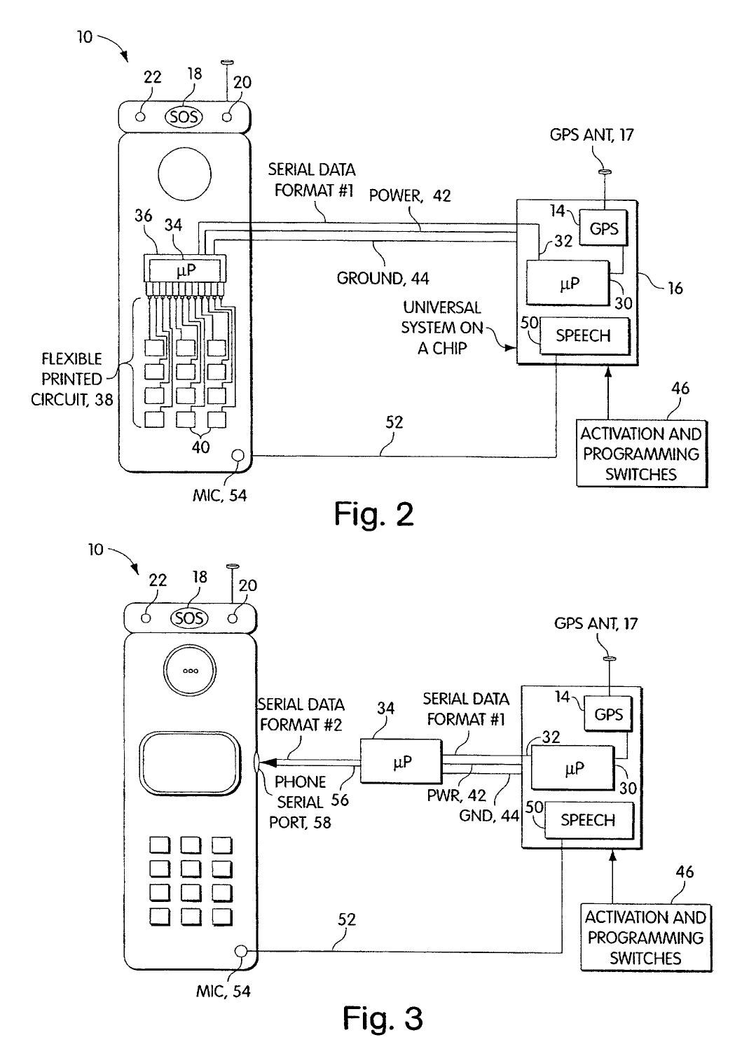

Referring now to FIG. 2, a situation is envisioned where the wireless phone does not have a compatible or existent bus structure for the control thereof. In this case module 16 by having been provided with its own microprocessor 30 has a serial output 32 coupled to a minicompiler 34 over a serial data line. The complier may itself be merely a microprocessor. Minicompiler 34 may be mounted, in one embodiment, on a flexible printed circuit 36 having leads generally indicated at 38 to be connected to the keypad 40 of the wireless phone. A power line 42 and a ground 44 are provided to minicompiler 34.

In operation, with activation and programming from switches 46 coupled to module 16, minicompiler 34 interprets the signals from microprocessor 30 and provides the requisite activations of the individual switches 40 of the keypad to perform the phone control functions. In this manner, the phone can be turned on, made to dial a number, and provide whatever information is appropriate from the activation of the switches on the keypad. Not only are the switches alpha-numeric switches, function control switches are also included within the subject invention.

In one embodiment, the location instead of being provided by activation of switches 40 can be provided by the output of a speech synthesizer 50 which is connected over wire 52 to the microphone 54 of the wireless phone.

The speech synthesizer can provide a verbal rendition of the information to be transmitted by the phone or it can function as a DTMF encoder so that once the phone has been turned on and has dialed a particular number, the location or other information can be provided by the output of speech synthesizer 50.

Referring now to FIG. 3, if the wireless phone has a pre-determined bus structure, then minicompiler 34 may be connected over bus 56 to the serial input port 58 which in and of itself has its own particular input data format for serial data. It also may have a parallel data port which functions likewise within the subject invention.

Again, it is the purpose of minicompiler 34 to be able to convert the data output from microprocessor 30 on bus 32 into that compatible with either the serial or parallel data input port for wireless phone 10.

What has therefore been accomplished is to be able to adapt a universal module, in the illustrated embodiment, a GPS location module, to be able to control an already existing phone without the modification of the universal module and without modification of the wireless phone. The advantage of being able to do so is to be able to port a particular system to any particular phone, regardless of its model. This results in the ability to produce a universal module, an output of which is modified for the particular existing phone by a compiler interposed between the output of the universal module and the phone itself.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method for the control of an existing wireless phone from a universal output comprising the steps of:
interposing a compiler between the module and the phone, the compiler reconfiguring the output of the module to signal which can control the functions of the phone; and,
applying the reconfigured output to the phone, whereby a universal module output is adapted to control the phone without modification of the existing phone or modification of the module, thus to adapt the module to control any existing phone.

2. The method of claim 1, wherein the exiting phone has a bus structure and wherein the compiler compiles the module output to a format compatible with the bus structure of the phone.

3. The method of claim 1, wherein the phone has a keypad, wherein the compiler compiles the module output into switch closure signals and wherein the reconfigured output applying step includes the step of providing the switch closure signals to the individual keys of the keypad to control the phone.

4. A system form marrying a universal module having an output of a wireless phone to an existing phone without having to modify either the universal module or the existing phone, comprising:
a compiler interposed between said module and said phone for converting the output of said module to signals capable of controlling said phone; and,
a circuit for connecting said converted output to said phone for the control thereof, whereby the programming and construction of said module remains invariant regardless of the existing phone it is to control.

5. The system of claim 4, wherein said existing phone has a predetermined bus structure for the control of said phone and wherein said compiler converts the output of said compiler to signals compatible with said predetermined bus structure.

6. The system of claim 5, wherein said phone has a data port and wherein said unit connects said output to said data port.

7. The system of claim 2, wherein said phone has a keypad with individual keys switches and wherein said circuit includes at least one conductor connected to one side of a key switch, a signal on said conductor effectuating closure of the corresponding key switch, whereby phone control from said module is accomplished through switch closing of the switches of said keypad, no access to the bus structure of said existing phone being necessary.

8. The system of claim 4, wherein said module includes a GPX receiver, wherein said module has as an output the location determining by said GPS-receiver and wherein said location output is converted by said compiler to a predetermined modulation scheme for said phone to permit location reporting from said phone.

9. The system of claim 8, wherein said modulation scheme includes DTMF tones and wherein said compiler outputs signals to said phone for causing generation of said DTMF tones, said DTMF tones reporting corresponding location as determined by said GPS receiver.

10. The system of claim 4, wherein the output of said module includes a telephone number to be dialed by said phone, and wherein the output of said compiler causes said phone to dial said telephone number.

11. The system of claim 4, wherein the output of said module includes data, and wherein said compiler outputs signals for the modulation of said phone to transmit said data.

12. The system of claim 11, wherein said data includes the mobile identification number of said phone.

13. The system of claim 11, wherein said data includes GPS related information.

14. The system of claim 13, wherein said GPS related information includes time-since-last fix.
